(19) United States
(12) Patent Application Publication
(10) Pub. No.: US 2025/0269776 A1
(43) Pub. Date: Aug. 28, 2025

(54) PADDING ELEMENT FOR A VEHICLE SEAT

(71) Applicant: Faurecia Sièges d’Automobile, Nanterre (FR)

(72) Inventors: Didier FOUINAT, SAINT-CHERON (FR); Fabrice ETIENNE, BAVILLIERS (FR); Marc THIEL, HERICOURT (FR)

(21) Appl. No.: 19/060,774

(22) Filed: Feb. 23, 2025

(30) Foreign Application Priority Data
Feb. 22, 2024 (FR) FR 2401758

(51) Int. Cl. B60N 2/58; B29C 45/14; B29K 105/04; B29L 31/00; B29L 31/30

(52) U.S. Cl. CPC B60N 2/5891; B29C 45/14; B29K 2105/04; B29L 2031/3005; B29L 2031/771

(57) ABSTRACT

A padding element for a vehicle seat includes a block of foam, the block having an outer surface and a groove, the groove having a bottom and side walls opening onto the outer surface. The padding element further includes an attachment support, arranged at the bottom of the groove. The attachment support includes: a contact surface, integral with the bottom of the groove; and a rib, arranged opposite the contact surface, in the direction of the outer surface of the foam block.

### TECHNICAL FIELD

The present invention relates to a padding element for a vehicle seat comprising a block of foam, said block comprising an outer surface and a groove, said groove comprising a bottom and side walls opening onto said outer surface; the padding element further comprising an attachment support, arranged at the bottom of the groove.

### BACKGROUND

Such a padding element is known in particular from document FR2815901, in the name of the applicant.

In order to secure the seat covering to the padding element, it is known practice to provide said padding element with attachment supports inserted into the foam and formed, for example, by metal rods, rigid plastic parts or hook-and-loop fasteners. Such configurations complicate operations for recycling padding elements.

### SUMMARY

An aim of the invention is to provide a padding element that combines good strength with a configuration that facilitates recycling.

To this end, one aspect of the invention is a padding element of the above-mentioned type, in which the attachment support comprises: a contact surface, integral with the bottom of the groove; and a rib, arranged opposite the contact surface, in the direction of the outer surface of the foam block.

According to other advantageous aspects of the invention, the padding element comprises one or more of the following features, taken alone or in any technically feasible combination:
the attachment support is formed from an unexpanded plastic material;
each one of the foam of the block and the unexpanded plastic material of the attachment support comprises polyurethane;
the contact surface and the rib of the attachment support extend continuously over a length of the groove of the foam block.

The invention also relates to a method for manufacturing a padding element as described above, the method comprising: a step of manufacturing the attachment support by molding the unexpanded plastic material; then a step of manufacturing the foam block via overmolding over said attachment support, so as to secure the contact surface of said attachment support to the bottom of the groove of the foam block.

According to other advantageous aspects of the invention, the manufacturing method comprises one or more of the following features, taken alone or in any technically feasible combination:
the step of manufacturing the attachment support comprises: providing a molding element comprising a channel complementary in shape to the rib of the attachment support; and pouring the plastic material in a fluid state into said channel, so that an upper surface of said plastic material forms the contact surface of the attachment support;
the molding element comprises flanks arranged on either side of the channel, said flanks having a shape complementary to the side walls of the groove of the foam block; and the step of manufacturing the foam block comprises overmolding over said molding element accommodating the attachment support, so as to form the groove, the bottom of said groove being integral with the contact surface of said attachment support.

The invention also relates to a padding element as described above, resulting from a manufacturing method as described above.

The invention further relates to a vehicle seat comprising: a padding element as described above; a flexible covering, in contact with the outer surface of said padding element; and a plurality of attachment elements, attached on the one hand to said flexible covering and on the other hand to the rib of the attachment support of the padding element.

Optionally, the vehicle seat is such that the plurality of attachment elements comprises at least one metal staple extending between two ends, said ends being inserted into the rib of the attachment support.

### BRIEF DESCRIPTION OF THE DRAWINGS

The invention will become clearer from reading the following description, provided solely by way of non-limiting example and with reference to the drawings, in which:

FIG. 1 is a partial view of a padding element according to one embodiment of the invention;

FIG. 2 is a detail cross-sectional view of a vehicle seat comprising the padding element of FIG. 1; and

FIGS. 3 and 4 are schematic representations of steps in a method for manufacturing the padding element shown in FIG. 1.

### DETAILED DESCRIPTION

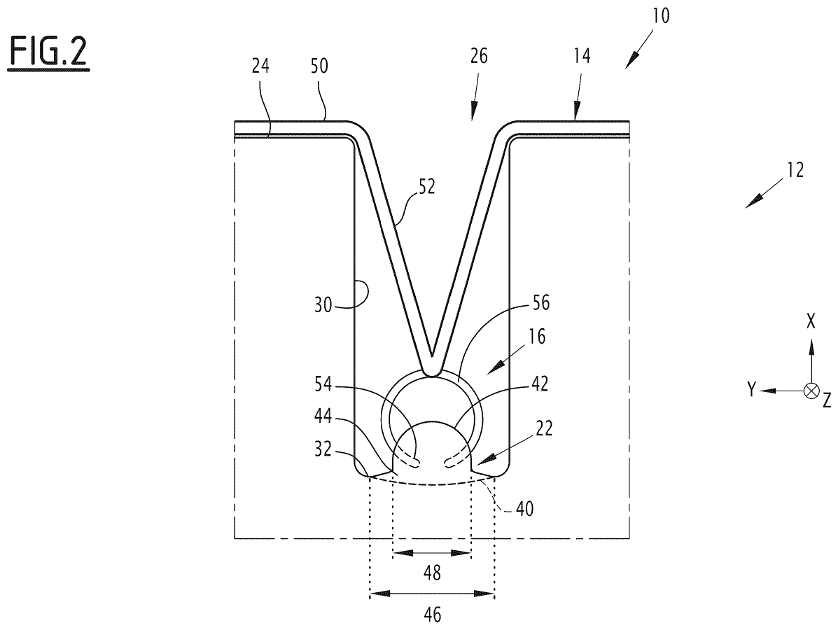

FIG. 2 is a detail cross-sectional view of a vehicle seat 10 according to one embodiment of the invention.

The seat 10 comprises in particular: a padding element 12; a covering 14; and a plurality of attachment elements 16. A single attachment element 16 is shown in FIG. 2.

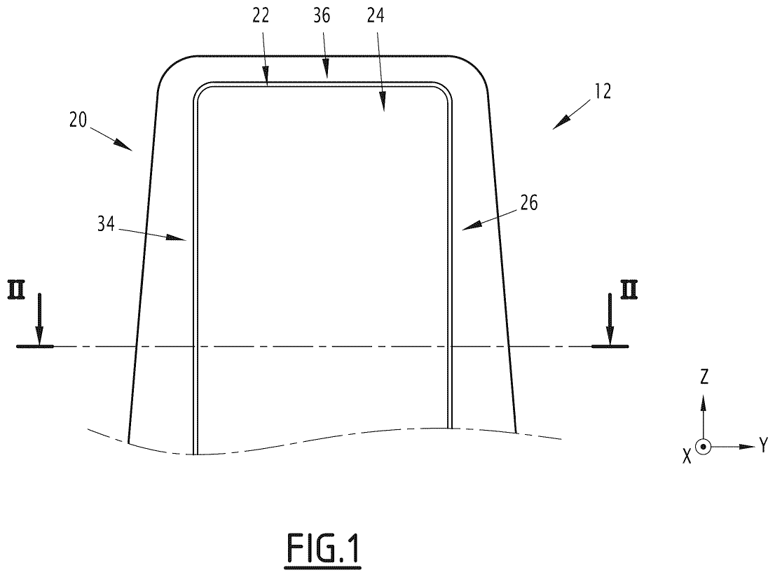

FIG. 1 shows a partial view of the padding element 12, in the sectional view of FIG. 2. In the embodiment shown in FIG. 1, the padding element 12 is intended for manufacture of a backrest for the seat 10. According to another embodiment (not shown), a padding element is used to manufacture a seat portion for the seat 10.

The padding element 12 comprises a block 20 and an attachment support 22.

The block 20 is formed from an elastically deformable foam, said foam being composed of a first plastic material. What is meant by “foam” is that block 20 has a flexible, open-cell honeycomb structure (not shown).

Preferably, the foam forming the block 20 has a density of between 30 Kg/m³ and 100 Kg/m³. Preferably, the foam forming the block 20 has a stress-strain characteristic in compression of between 3 KPa and 20 KPa according to DIN EN ISO 3386.

Preferably, the first plastic material comprises polyurethane.

The block 20 comprises an outer surface 24 and a groove 26. As described in greater detail below, the outer surface 24 is intended to be covered by the covering 14 for contact with part of the body of a user of the seat 10.

An orthonormal coordinate system (X, Y, Z) associated with the padding element 12 is used. In the embodiment shown, the outer surface 24 of the block 20 extends substantially in a plane (Y, Z).

The groove 26 extends over the outer surface 24, as shown in FIG. 1. More precisely, as shown in FIG. 2, the groove 26 comprises two side walls 30, leading out to said external surface 24. The groove 26 further comprises a bottom 32, arranged opposite the outer surface 24 with respect to the side walls 30.

In the embodiment shown, the side walls 30 are substantially parallel to one another. Furthermore, in the embodiment shown, the side walls 30 are substantially parallel to the direction X.

In one variant (not shown), the distance between the side walls of the groove increases slightly between the bottom 32 of the groove and the outer surface 24 of the block 20. For example, the side walls form an angle with one another of between 0° and 15°.

The depth of the groove 26 in the direction X, between the bottom 32 and the outer surface 24, is preferably between 5 mm and 3 cm, more preferably between 15 mm and 25 mm.

Preferably, the groove 26 extends continuously over the outer surface 24 and comprises substantially straight portions and/or curved portions. In the embodiment shown, the groove 26 is substantially U-shaped, comprising two side portions 34 extending substantially along Z and an upper portion 36 extending substantially along Y. Each of the side portions 34 is continuous with the upper portion.

In one variant (not shown), the groove 26 closes in on itself, forming a rectangle or square, for example. Such a shape is particularly suitable for a seat portion of a seat (not shown).

According to another variant (not shown), the groove 26 is substantially H-shaped.

The shape of the groove 26 on the outer surface 24 lends a certain esthetic appearance to the padding element 12, ensures satisfactory application of the covering 14 to the padding element 12 and provides a certain level of comfort for the passenger.

The attachment support 22 is arranged at the bottom of the groove 26.

More specifically, the attachment support 22 comprises a contact surface 40 and a rib 42. The contact surface 40 is integral with the bottom 32 of the groove 26. The rib 42 is arranged opposite the contact surface 40, in the direction of the outer surface 24.

Preferably, the contact surface 40 and the rib 42 of the attachment support extend continuously over a length of the groove 26 of the foam block. Like said groove, the attachment support 22 comprises substantially straight portions and/or curved portions.

Preferably, the attachment support 22 comprises a base 44 forming the contact surface 40. The rib 42 projects from said base 44, opposite the contact surface 40. More preferably, the base 44 has a width 46 greater than a width 48 of the rib 42, perpendicular to a main direction of the groove 26.

Preferably, the attachment support 22 is formed from a second plastic material. More preferably, the second plastic material is unexpanded, i.e. said second material does not comprise a cellular structure. In other words, said second material is a homogeneous or bulk material.

Preferably, the second plastic material has a density of between 600 Kg/m³ and 900 Kg/m³. Preferably, the second plastic material has a Shore A hardness of between 60 and 100.

Preferably, the second plastic material comprises polyurethane.

The covering 14 of the seat 10 forms a flexible layer. The covering 14 is formed, for example, from a natural or synthetic textile material, or from natural or synthetic leather.

The covering 14 comprises: a main region 50, in contact with the outer surface 24 of the foam block 20; and an attachment region 52, arranged in the groove 26.

For example, the covering 14 comprises a plurality of layers, in particular a base layer, a split foam layer and an appearance layer.

Each of the plurality of attachment elements 16 is attached on the one hand to the rib 42 of the attachment support 22 of the padding element 12 and, on the other hand, to the attachment region 52 of the covering 14.

In the embodiment shown, the attachment element 16 has a curved shape, extending between two ends 54. The attachment element 16 further comprises a central portion 56 arranged between said ends 54.

Each end 54 of the attachment element 16 is inserted into the rib 42 of the attachment support 22. The central portion 56 of the attachment element 16 is attached to the attachment region 52 of the covering 14.

Preferably, the attachment element 16 is a metal staple, for example a self-piercing deformable metal staple. Preferably, the plurality of attachment elements 16 is distributed along the length of the groove 26.

In the embodiment shown, the attachment element 16 is attached in contact with the attachment region 52 of the covering 14. According to one variant (not shown), the seat 10 further comprises a plurality of return elements, each of said return elements being attached on the one hand to the central portion 56 of an attachment element 16 and, on the other hand, to the attachment region 52 of the covering 14

A method for manufacturing the above padding element 12 will now be described.

The manufacturing method comprises: a first step of manufacturing the attachment support 22 by molding the second plastic material; and then a second step of manufacturing the foam block 20 by overmolding over said attachment support 22. The contact surface 40 of said attachment support 22 is thus made integral with the bottom 32 of the groove 26 of the foam block 20.

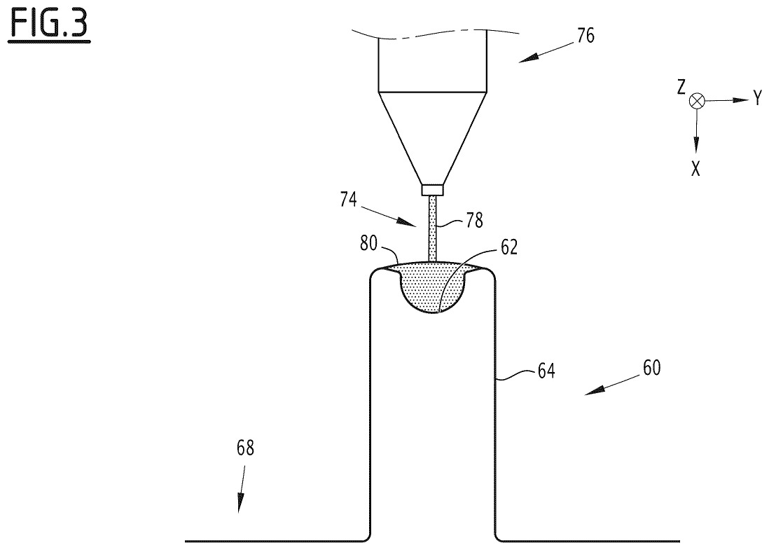

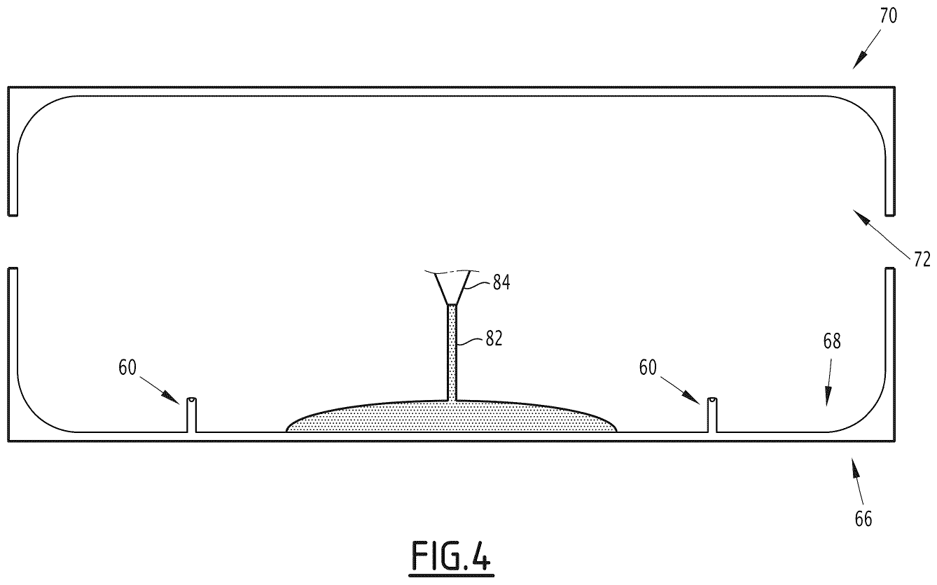

FIGS. 3 and 4 schematically show the steps of the above-mentioned manufacturing method.

In particular, FIG. 3 shows a schematic cross-sectional view of a molding element 60 for carrying out the first step, of manufacturing the attachment support 22.

The molding element 60 comprises a channel 62, complementary in shape to the rib 42 of the attachment support. In the embodiment shown, the molding element 60 comprises flanks 64, arranged on either side of the channel 62. The shape of the flanks 64 is complementary to that of the side walls 30 of the groove 26 of the foam block 20. The channel 62 is arranged at one end of the flanks 64.

In the embodiment shown, the molding element 60 is formed in one piece with a mold 66 shown in FIG. 4. As a variant, the molding element 60 is an additional part added and secured to the mold 66.

The mold 66 comprises a mold bottom 68, complementary in shape to the outer surface 24 of the block 20. The flanks 64 of the molding element 60 project from the mold bottom 68, with the channel 62 arranged opposite said mold bottom.

The molding element 60 is arranged on the mold bottom 68 along a path corresponding to that of the groove 26 on the outer surface 24 of the block 20. For example, according to the embodiment shown, the molding element 60 is integral with the mold bottom 68.

In the embodiment shown in FIG. 4, the mold 66 further comprises a cover 70, which can be removably added to the mold bottom 68 in order to define a closed enclosure 72. An inner shape of said enclosure is complementary to an outer shape of the padding element 12.

Preferably, the mold 66 comprises vents (not shown) for venting the enclosure 72.

According to one preferred embodiment, the first step, of manufacturing the attachment support 22, proceeds as follows:

First, the molding element 60 is arranged so that the opening of the channel 62 is faces upward.

A first fluid composition 74 is then used in a first injection head 76. The first fluid composition 74 is a precursor for the second plastic material forming the attachment support 22

Preferably, the first fluid composition 74 is obtained by mixing a first component, comprising an isocyanate resin, and a second component, comprising a polyol. For example, the second component comprises one or more polyols, and additives. The first fluid composition 74 thus allows a polyurethane to be obtained.

More preferably, a water content of the first fluid composition 74 is less than 0.5% by weight relative to the weight of polyols, so as to obtain a dense material.

Next, the first injection head 76 is arranged above the channel 62 of the molding element 60; and then a bead 78 of first fluid composition 74 is poured into said channel 62 as the first injection head 76 is moved along a length of said channel. Preferably, a cross section of the bead 78 is between 0.2 cm² and 0.6 cm². Preferably, a flow rate of the first fluid composition 74 is between 3 cm³ and 50 cm³ per second, so as to maintain a substantially laminar flow.

The channel 62 of the molding element is thus filled with the first fluid composition 74. After curing, an upper surface 80 of the obtained second plastic material forms the contact surface 40 of the attachment support 22. The material filling the channel 62 forms the rib 42 of said attachment support.

According to one preferred embodiment, the second step, of manufacturing the foam block 20, proceeds as follows:

After the first fluid composition 74 has been poured, with the attachment support 22 still accommodated in the channel 62 of the molding element 60, a second fluid composition 82 (FIG. 4) is used in a second injection head 84. The second fluid composition 82 is a precursor for the foam forming the block 20 of the padding element 12.

According to one preferred embodiment, the second fluid composition 82 comprises a mixture of the first and second components described above, comprising an isocyanate resin and a polyol, respectively. A foaming agent such as water is also added. Preferably, a water content of the second fluid composition 82 is between 0.5% and 6% by weight relative to the weight of polyols. The second fluid composition 82 thus allows an expanded material, such as a polyurethane foam, to be obtained.

Next, with the mold 66 open, the second injection head 84 is positioned above the mold bottom 68 and the second fluid composition 82 is poured onto said bottom 68. Preferably, a flow rate of second fluid composition 82 is greater than 150 cm³ per second.

The mold 66 is then closed by assembling the mold bottom 68 and the cover 70 together, forming the enclosure 72. The second fluid composition 82 expands, filling said enclosure 72 to form the foam block 20.

As the second fluid composition 82 expands, said second fluid composition engulfs the molding element 60 bearing the attachment support 22. The contact surface 40 of said support is thus covered by the foam as it forms.

The groove 26 of the block 20 is thus formed around the molding element 60. In addition, the bottom 32 of said groove is attached to the contact surface 40 of the attachment support 22.

According to a first alternative, the second fluid composition 82 is poured while the first fluid composition 64, in the channel 62, is still curing. According to a second alternative, the second fluid composition 82 is poured after the first fluid composition 74 has cured. In both cases, good adhesion is achieved between the contact surface 40 of the attachment support 22 and the bottom 32 of the groove 26.

Preferably, the mold 66 is closed after the second fluid composition 82 has already partially expanded. This facilitates venting of the mold.

Once the second fluid composition 82 has cured, forming the foam block 20, the resulting padding element 12 is removed from the mold.

According to one preferred embodiment, prior to the first and second steps described above, the manufacturing method comprises the application of a mold release agent to the molding element 60 and to the mold bottom 68. Such a mold release agent is, for example, in the form of a liquid solution, sprayed onto the surfaces in question.

After the padding element 12 has been obtained, the seat 10 is obtained by stapling each of the attachment elements 16 along the rib 42 of the attachment support 22, said attachment elements 16 having been previously joined to the attachment region 52 of the covering 14.

According to one alternative (not shown), the attachment elements 16 are first stapled along the rib 42 of the attachment support 22, and then the covering 14 is joined to said attachment elements 16 by means of a plurality of return elements (not shown).

According to another alternative, the attachment elements 16 are each stapled simultaneously to the attachment region 52 of the covering 14 and to the rib 42 of the attachment support 22, for example using a pressure-applying tool which deforms the attachment element 16 so as to perforate the rib 42 and the region 52 and then form the attachment element 16 into a substantially closed loop.

For example, attachment elements 16 are distributed along rib 42 so that each attachment element 16 is separated from its neighbors by a substantially regular distance.

The padding element 12 described above exhibits good mechanical strength by virtue of the adhesion between the foam block 20 and the attachment support 22.

Moreover, such a padding element 12 formed from plastic material, without metal inserts, facilitates recycling operations. To this end, the foam block 20 and the attachment support 22 are advantageously formed from similar materials, comprising polyurethane in particular.

1. A padding element for a vehicle seat, comprising a block of foam, said block comprising an outer surface and a groove, said groove comprising a bottom and side walls opening onto said outer surface; the padding element further comprising an attachment support, arranged at the bottom of the groove;
wherein the attachment support comprises: a contact surface, integral with the bottom of the groove; and a rib, arranged opposite the contact surface, in the direction of the outer surface of the foam block.

2. The padding element as claimed in claim 1, wherein the attachment support is formed from an unexpanded plastic material.

3. The padding element as claimed in claim 2, wherein each one of the foam of the block and the unexpanded plastic material of the attachment support comprises polyurethane.

4. The padding element as claimed in claim 1, wherein the contact surface and the rib of the attachment support extend continuously over a length of the groove of the foam block.

5. A method for manufacturing a padding element as claimed in claim 2, comprising: manufacturing the attachment support by molding the unexpanded plastic material; and manufacturing the foam block via overmolding over said attachment support, so as to secure the contact surface of said attachment support to the bottom of the groove of the foam block.

6. The manufacturing method as claimed in claim 5, wherein the step of manufacturing the attachment support comprises: providing a molding element comprising a channel complementary in shape to the rib of the attachment support; and pouring the plastic material in a fluid state into said channel, so that an upper surface of said plastic material forms the contact surface of the attachment support.

7. The manufacturing method as claimed in claim 6, wherein: the molding element comprises flanks arranged on either side of the channel, said flanks having a shape complementary to the side walls of the groove of the foam block; and the step of manufacturing the foam block comprises overmolding over said molding element accommodating the attachment support, so as to form the groove, the bottom of said groove being integral with the contact surface of said attachment support.

8. The padding element as claimed in claim 2, wherein the padding element is made by a manufacturing method comprising: manufacturing the attachment support by molding the unexpanded plastic material; and manufacturing the foam block via overmolding over said attachment support, so as to secure the contact surface of said attachment support to the bottom of the groove of the foam block.

9. A vehicle seat, comprising: a padding element as claimed in claim 1; a flexible covering, in contact with the outer surface of said padding element; and a plurality of attachment elements, attached to said flexible covering and to the rib of the attachment support of the padding element.

10. The vehicle seat as claimed in claim 9, wherein the plurality of attachment elements comprises at least one metal staple extending between two ends, said ends being inserted into the rib of the attachment support.
